(19) United States
(12) Patent Application Publication
(10) Pub. No.: US 2006/0095826 A1
(43) Pub. Date: May 4, 2006

(54) Semiconductor memory chip, semiconductor memory module and method for transmitting write data to semiconductor memory chips

(76) Inventors: Hermann Ruckerbauer, Moos (DE); Doninique Savignac, Ismaning (DE); Peter Gregorius, Munchen (DE); Christian Sichert, Munchen (DE); Paul Wallner, Prien (DE)

Correspondence Address: EDELL, SHAPIRO & FINNAN, LLC, 1901 RESEARCH BLVD., SUITE 400, ROCKVILLE, MD, 20850, US

(21) Appl. No.: 11/261,911

(22) Filed: Oct. 31, 2005

(30) Foreign Application Priority Data
Oct. 29, 2004 (DE) 10 2004 052 612.5

(51) Int. Cl. H04L 1/18; G08C 25/02

(52) U.S. Cl. 714/748

(57) ABSTRACT

A semiconductor memory module includes a plurality of semiconductor memory chips. Each semiconductor memory chip includes an interface circuit that is configured to detect a transmission error in a write datum and is further configured to output, via a separate signal path, a repeat request signal for the repeated transmission of the write datum detected as erroneous. This repeat request signal can be transmitted either as a single-bit signal or as a multibit signal (e.g., serially as an individual signal line to a superordinate memory controller).

### CROSS REFERENCE TO RELATED APPLICATIONS

This application claims priority under 35 USC § 119 to German Application No. DE 10 2004 052 612.5, filed on Oct. 29, 2004, and titled “Semicondcutor Memory Chip, Semiconductor Memory Module and Method for Transmitting Write Data to Semiconductor Memory Chips,” the entire contents of which are hereby incorporated by reference.

### FIELD OF THE INVENTION

The invention relates to a semiconductor memory chip including an interface circuit which is set up at least for receiving write data and also for detecting a transmission error in the received write data, a semiconductor memory module equipped with a plurality of semiconductor memory chips of this type, and a method for transmitting write data to at least one semiconductor memory chip of this type.

### BACKGROUND

At the increasing data transmission speeds of future DRAM generations, the data signals need to be transmitted differentially, which can increase the error protection in the event of bit errors caused by the transmission. It is desirable for the semiconductor memory modules operating at such a high data transmission speed also to be able to perform a data consistency check at least in the case of the data written to the memory chips.

In the case of DIMM memory modules equipped with fast semiconductor memory chips for servers or workstations, hitherto a separate ECC-DRAM has been provided for error detection or error correction purposes, which ECC-DRAM stores ECC checksums for the purpose of registering a transmission error of the write data on the transmission channel. The checksums are generated by the memory controller, written to the ECC-DRAM during the writing operation and transmitted back to the memory controller again during the reading operation. The memory controller can detect data errors, and repair them in part, by means of an error detection/correction algorithm implemented in it. This mechanism acts in the event of transmission errors and in the event of an error in the DRAM array. However, customary DIMM memory modules for desktop personal computers do not usually have a possibility for error detection or correction. An added further DRAM for error detection and/or correction, which does not serve for storing data, would disproportionately increase the costs of such a device.

On the other hand, consideration is given to equipping the DRAM memory chips with simple error detection. Such error detection would be embodied in the interface circuit in each semiconductor memory chip.

Various methods and algorithms are proposed in the art for detecting data errors. One of these methods can detect an error in an n-bit wide datum by transmitting with this datum an individual check bit that supplements the original n-bit datum such that the resultant number of ones (or zeros) in the supplemented datum is always an even number (or an odd number).

Other known error detection measures use data block formation or specific coding of the data.

### SUMMARY OF THE INVENTION

In view of the above, it is an object of the invention, in the case of a semiconductor memory chip equipped with an interface circuit of this type and also in the case of a semiconductor memory module equipped with semiconductor memory chips of this type, to enable simple, cost-effective error correction which does not adversely affect the traffic on the data bus.

The above and other objects are achieved in accordance with the invention, by providing a semiconductor memory chip comprising an interface circuit that is configured at least to receive write data and also to detect a transmission error in the received write data. If a transmission error is detected, the interface circuit is configured to output, via a separate request signal path, a repeat request signal to repeat transmission of a write datum detected as erroneous.

In a preferred embodiment of the invention, the semiconductor memory chip is configured such that the interface circuit outputs the repeat request signal on an individual separate signal line, e.g. as a single-bit signal. The interface circuit can be configured such that it outputs the repeat request signal as a multibit signal. The multibit signal can also be output in coded fashion. The coding of the repeat request signal makes it possible for the interface circuit to inform, e.g., a superordinate memory controller that it requires more time for an error correction than until the next write cycle.

In accordance with a second embodiment of the invention, a semiconductor memory module comprises a plurality of semiconductor memory chips each including an interface circuit that is configured at least to receive write data and to detect a transmission error in a received write datum. Each interface circuit, if it has detected a transmission error in the write data, is configured to output, via a separate request signal path, a repeat request signal for the repeated transmission of a write datum detected as erroneous. Each request signal path can be led from the interface circuit as an individual signal line separately to a respective external terminal contact of the semiconductor memory module. As an alternative, each request signal path led as an individual line from the interface circuit can be ORed by an OR circuit on the semiconductor memory module and the output signal thereof can be passed as an individual signal line to a terminal contact of the semiconductor memory module.

In a further embodiment, each request signal can be output from the respective interface circuit of the semiconductor memory chip as a multibit signal. The interface circuit can be set up to output the repeat request signal in coded fashion.

In accordance with a third embodiment of the invention, a method for transmitting write data to a semiconductor memory chip comprises a first step of transmitting the write data to the semiconductor chip externally via a data transmission path, and a second step of detecting a possible transmission error in the received write datum. The method further comprises a third step in which, if a transmission error is detected in the second step, a repeat request signal for the repeated transmission of a write datum detected as erroneous is output via a request signal path, which is separate from the data transmission path, from the semiconductor memory chip.

In accordance with a fourth embodiment of the invention, a method for transmitting write data to a plurality of semiconductor memory chips arranged on a semiconductor memory module comprises a first step of transmitting write data at least to one of the semiconductor memory chips externally via a data transmission path, and a second step in which, in each semiconductor memory chip, a received write datum is checked for a transmission error. The method further comprises a third step in which, if a transmission error is detected in the second step, a repeat request signal for the repeated transmission of the write datum detected as erroneous is output via a request signal path, which is separate from the data transmission path, from the relevant semiconductor chip.

One advantage of the semiconductor memory chip according to the invention, of the semiconductor memory module according to the invention and also of the transmission methods respectively in accordance with the first to fourth embodiments of the invention, is the fact that the repeat request signal only has to be sent at a low rate, e.g., one repeat request signal per burst (e.g. at a frequency of 100 MHz).

A further advantage of the of the present invention is that the repeat request signal can be output only via one signal line, e.g., via one pin on the semiconductor memory chip, thus avoiding any problems in the pin allocation on the semiconductor memory chip and enabling on the semiconductor memory module. In addition, this allows for simple line routing and reliable transmission of the repeat request signals from the plurality of semiconductor memory chips arranged on the semiconductor memory module to a superordinate controller unit, e.g. via a repeat request signal bus separate from the data transmission bus.

The above and still further objects, features and advantages of the present invention will become apparent upon consideration of the following detailed description of specific embodiments thereof, particularly when taken in conjunction with the accompanying drawings where like numerals designate like components.

### BRIEF DESCRIPTION OF THE DRAWINGS

FIG. 1 schematically shows a plan view of a first exemplary embodiment of a semiconductor memory module equipped with a plurality of semiconductor memory chips according to the invention in connection with a memory controller.

FIG. 2 schematically shows a plan view of a second exemplary embodiment of a semiconductor memory module according to the invention equipped with semiconductor memory chips according to the invention.

FIG. 3 schematically shows a plan view of a third exemplary embodiment of a semiconductor memory module equipped with a plurality of semiconductor memory chips according to the invention and a register unit in connection with a memory controller.

FIG. 4 schematically shows a plan view of a fourth preferred exemplary embodiment of a semiconductor memory module equipped with a plurality of semiconductor memory chips according to the invention in connection with a memory controller.

### DETAILED DESCRIPTION

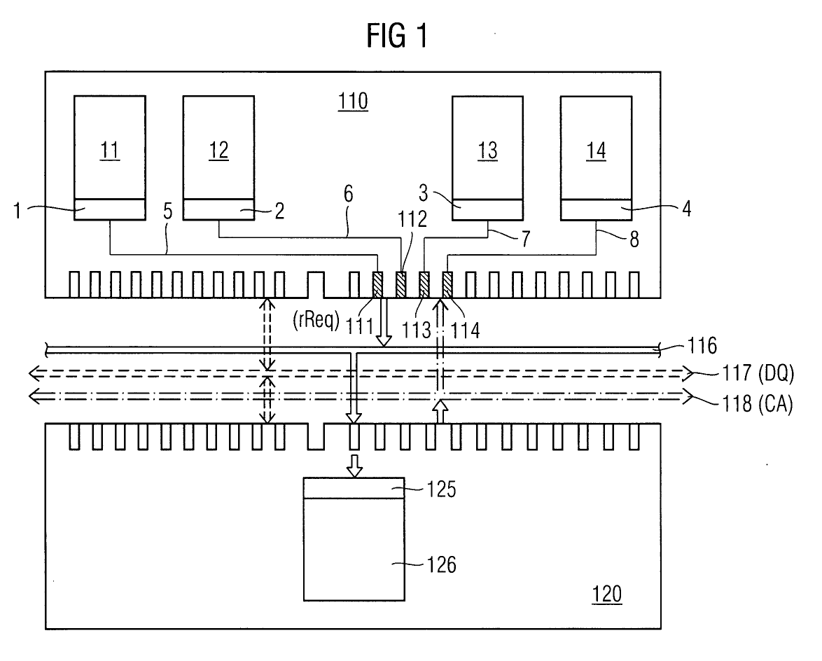

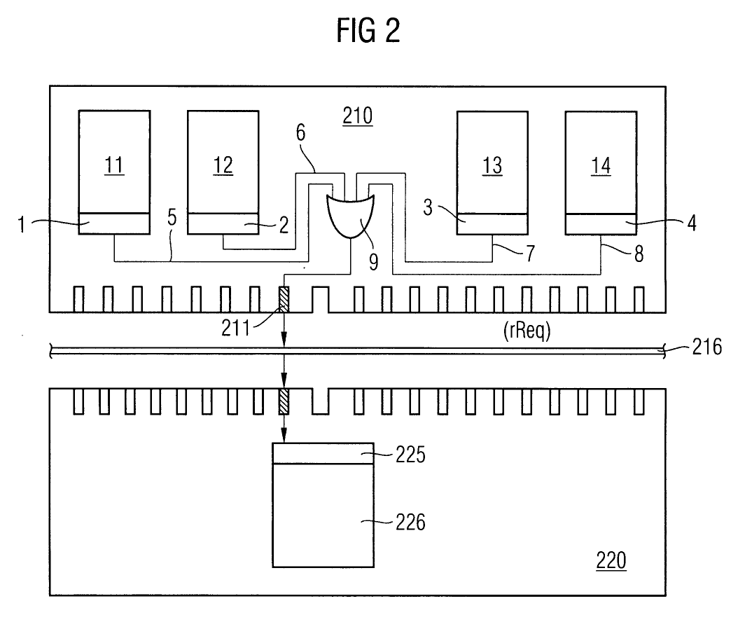

A common feature of each of the semiconductor memory modules 110, 210, 310 and 410 according to the invention that are illustrated schematically in FIGS. 1 to 4 is that they are equipped with a plurality (e.g. four) of semi-conductor memory chips 11 to 14 each including an interface circuit 1-4, which receive a write datum sent via a data bus (DQ bus) 117 from a memory controller 120, 220, 320 in response to a command and address signal transmitted via a CA bus 118, and are configured to detect a transmission error in the respectively received write datum (it should be noted that a DQ bus 117 and a CA bus 118 are shown only in FIG. 1 and are omitted in FIGS. 2 to 4 for a simplified illustration).

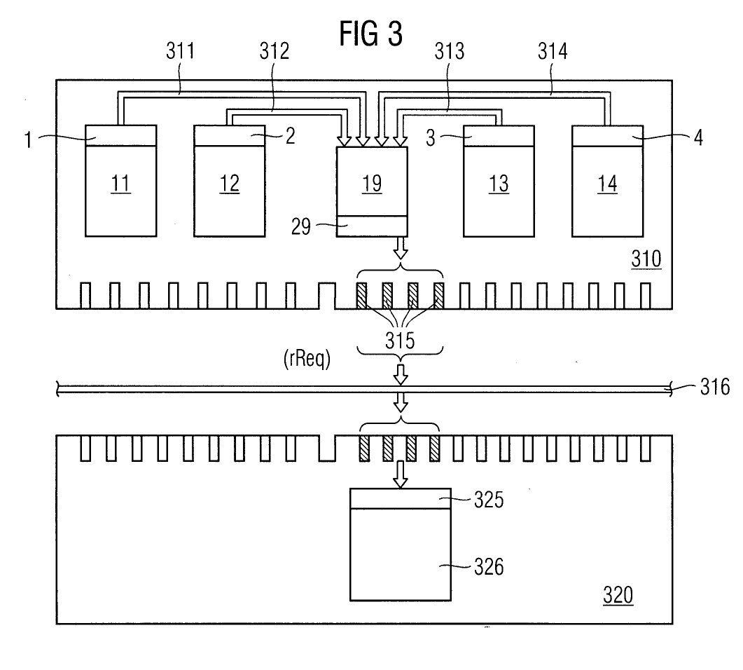

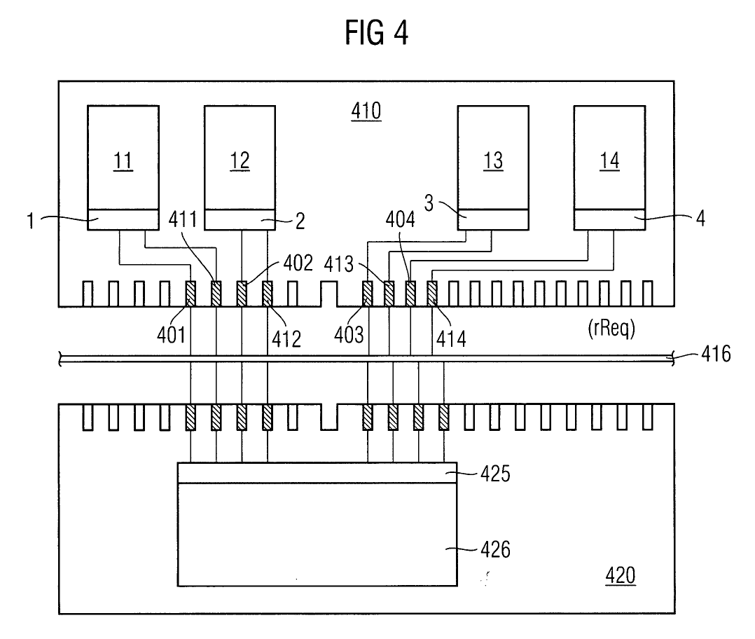

According to the invention, each interface circuit 1-4, if it has detected a transmission error in the write data, is configured to output, via a request signal path 5-8 (which are separate from the DQ bus) in FIGS. 1 and 2, 311-314 in FIG. 3, and 401, 411, 402, 412, 403, 413, 404 and 414 in accordance with FIG. 4, a repeat request signal rReq for the repeated transmission of a write datum detected as erroneous.

It should be noted that a plurality of semiconductor memory modules of the type shown in FIGS. 1-4 can be connected to a memory controller 120, 220, 320 and 420. In this connection, the repeat request signals rReq are transmitted from the plurality of semiconductor memory modules to the memory controller via a repeat request signal bus (rReq bus) 116, 216, 316 and 416, respectively.

In response to the reception of a repeat request signal from one of the memory chips, the memory controller 120, 220, 320 or 420, respectively, then repeats the transmission of the write data, so that the interface circuit 1-4 of the memory chips that is adapted therefor can execute an error correction algorithm.

It should furthermore be noted that, in the case of the first exemplary embodiment illustrated in FIG. 1, the repeat request signals run from each interface circuit 1-4 of each semiconductor memory chip 11-14 separately via an individual line to respective individual terminal contacts 111-114 of the semiconductor memory module 110 and from there onward via the aforementioned rReq bus 116 to the memory controller 120, where these four individual signals are buffer-stored by a register unit 126 equipped with an interface circuit 125.

The second exemplary embodiment shown in FIG. 2 differs from the first exemplary embodiment described above in that the repeat request signals transmitted from the interface circuits 1-4 of the semiconductor memory chips 11-14 arranged on the semiconductor memory module 210 via individual signal lines 5-8 are ORed by an OR element 9 arranged on the semiconductor memory module 210, the output signal of the OR element is then passed to an individual terminal contact 211 of the semiconductor memory module 210 by an individual signal line. A pull-down driver element (not shown) can be provided between the output of the OR element 9 and the terminal contact 211 of the semiconductor memory module 210. The second exemplary embodiment of the invention as shown in FIG. 2 has the advantage over the exemplary embodiment in FIG. 1 in that the number of terminal contacts of the semiconductor memory module 210 that are required for the repeat request signal is reduced compared with the first exemplary embodiment shown in FIG. 1, since each semiconductor memory module 210 then requires, at its contact strip, only one terminal contact 211 to transmit the repeat request signal to the memory controller 220.

It should be emphasized that the repeat request signal in the case of the first and second exemplary embodiment in accordance with FIGS. 1 and 2 can be transmitted either as a single-bit signal or as a serial multibit signal. In the latter case, the repeat request signal can be output in coded fashion (i.e., as a coded signal), so that it can transmit, e.g., information such as “needs more time for the error correction” to the memory controller 120 or 220, respectively.

In the case of the third exemplary embodiment of the invention as illustrated in FIG. 3, the repeat request signals are transmitted from the interface circuits 1-4 of the semiconductor memory chips 11-14 arranged on the semiconductor module 310 in each case as a multibit signal via respective parallel repeat request signal lines 311-314 to a register unit 19 arranged on the semiconductor memory module 310, where they are buffer-stored. From an interface circuit 9 of the register unit 19, the repeat request signal rReq present as a multibit signal can be transmitted via a plurality of terminal contacts 315 of the semiconductor memory module 310 via the rReq bus 316 to the memory controller 320, e.g. to an interface circuit 325 of a register unit 326 arranged on the memory controller 320. It goes without saying that the repeat request signal transmitted as a multibit signal can, in this case as well, be transmitted in coded fashion (i.e., as a coded signal) and as a result transmit more information than just “repeat the write datum”.

The fourth exemplary embodiment of the invention as illustrated in FIG. 4 differs from the third exemplary embodiment described above and illustrated in FIG. 3 in that the semiconductor memory module 410 of FIG. 4 does not contain a register unit, and in that the repeat request signals transmitted via parallel signal lines from the interface circuits 1-4 of the semiconductor memory chips 11-14 are thus transmitted to individual terminal contacts 401, 411, 402, 412, 403, 413, 404, 414 of the semiconductor memory module 410 and from there onward via an rReq bus 416 to the interface circuit 425 of a register unit 426 situated on the memory controller 420 and are buffer-stored in the register circuit 426. The last-mentioned fourth exemplary embodiment also enables coded multibit transmission of the respective repeat request signals from the individual memory chips 11-14.

It should be mentioned that a read error that occurs on the DQ transmission channel when reading data from the semiconductor memory chips can be detected and corrected in a simple manner by the memory controller by the memory controller simply performing a further read operation.

The exemplary embodiments of a semiconductor memory module according to the invention and of a semiconductor memory chip according to the invention as described above with reference to FIGS. 1-4 enable a method for transmitting write data to one or more semiconductor memory chip(s) arranged on a semiconductor memory module, a first step involving transmission of write data externally (e.g. from the memory controller) to the semiconductor memory chip via a data transmission path, and a second step involving detection of a transmission error that has possibly arisen as a result of the transmission in a received write datum. According to the invention, the method has a third step in which, if a transmission error is detected in the write data in the second step, a repeat request signal rReq for the repeated transmission of the write datum detected as erroneous is output via a separate request signal path from the semiconductor memory chip.

This method advantageously enables error correction of write data received in the semiconductor memory chip, in the case where the write data have been detected as erroneous, with a low outlay, to be precise without a separate ECC chip having to be arranged on a semiconductor memory module equipped with semiconductor memory chips.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

List of reference symbols

| | |
|---|---|
| 1-4 | Interface circuit |
| 5-8 | Individual signal line |
| 9 | OR element |
| 11-14 | Semiconductor memory chip |
| 19, 29 | Register circuit and |
| | interface circuit thereof |
| 110, 210, 310, 410 | Semiconductor memory module |
| 111-114, 211 | Individual terminal contacts |
| 116, 216, 316, 416 | rReq bus |
| 117 | DQ bus |
| 118 | CA bus |
| 120, 220, 320, 420 | Memory controller unit |
| 125, 126; 225, 226; | Interface circuit and |
| 325, 326; 425, 426 | associated register |
| | unit on the memory |
| | controller unit |
| 311-314 | Multibit request signal lines |
| 315; 401, 411, 402, 412, | Multibit terminal contacts on 403, 413, 404, |
| 414 | the semiconductor memory module |
| rReq | Repeat request signal |

What is claimed:

1. A semiconductor memory chip comprising:
an interface circuit configured to receive write data and to detect a transmission error in the received write data, wherein, upon detection of a transmission error by the interface circuit, the interface circuit is further configured to output, via a request signal path, a repeat request signal for the repeated transmission of a write datum detected as erroneous.

2. The semiconductor memory chip of claim 1, wherein the interface circuit is configured to output the repeat request signal on an individual separate signal line.

3. The semiconductor memory chip of claim 1, wherein the interface circuit is configured to output the repeat request signal as a multibit signal. The semiconductor memory chip of claim 3, wherein the interface circuit outputs the repeat request signal in coded fashion.

4. A semiconductor memory module comprising a plurality of semiconductor memory chips, each semiconductor memory chip comprising an interface circuit configured to receive write data and to detect a transmission error in a received write datum, wherein, upon detection of a transmission error in the write data by an interface circuit, each interface circuit is configured to output, via a separate request signal path, a repeat request signal for the repeated transmission of a write datum detected as erroneous.

5. The semiconductor memory module of claim 4, wherein each request signal path is led as an individual signal line separately to a respective external contact of the semiconductor memory module.

6. The semiconductor memory module of claim 4, wherein each request signal path is led from a respective interface circuit as an individual signal line to an OR circuit on the semiconductor memory module, the output signal of the OR circuit being passed via an individual signal line to a terminal contact of the semiconductor memory module.

7. The semiconductor memory module of claim 4, wherein the request signal is passed by each semiconductor memory chip as a multibit signal.

8. The semiconductor memory module of claim 7, wherein each interface circuit is further configured to output the repeat request signal in coded fashion.

9. A method for transmitting write data to a semiconductor memory chip, the method comprising:
transmitting write data to the semiconductor chip externally via a data transmission path;
detecting a transmission error in the received write datum; and
upon detection of a transmission error in the received write datum, outputting a repeat request signal for the repeated transmission of a write datum detected as erroneous via a separate request signal path from the semiconductor memory chip.

10. The method of claim 9, wherein the repeat request signal is output as a single-bit signal.

11. The method of claim 9, wherein the repeat request signal is output as a multibit signal.

12. The data transmission method as claimed in claim 11, wherein the repeat request signal is output in coded fashion.

13. A method for transmitting write data to a plurality of semiconductor memory chips arranged on a semiconductor memory module, the method comprising:
transmitting write data to at least one of the semiconductor memory chips externally via a data transmission path;
in each semiconductor memory chip, checking a received write datum and detecting a transmission error; and
upon detection of a transmission error in each semiconductor memory chip, outputting a repeat request signal for the repeated transmission of the write datum detected as erroneous via a separate request signal path from the respective semiconductor chip.

14. The method of claim 13, wherein the repeat request signal of each semiconductor memory chip is output from each semiconductor memory chip as a single-bit signal.

15. The method of claim 13, wherein the repeat request signal of each semiconductor memory chip is passed from each semiconductor memory chip separately to a respective terminal contact of the semiconductor memory module.

16. The method of claim 13, wherein each of the repeat request signals is passed from the respective semiconductor memory chip on the semiconductor circuit module as a single-bit signal to an individual terminal contact of the semiconductor memory module.

17. The method of claim 13, wherein the repeat request signal of each semiconductor memory chip is output from the respective semiconductor memory chip as a multibit signal.

18. The method of claim 17, wherein the repeat request signal of each semiconductor memory chip is output in coded fashion.
